(19) United States
(12) Patent Application Publication
(10) Pub. No.: US 2014/0195223 A1
(43) Pub. Date: Jul. 10, 2014

(54) METHOD AND SYSTEM FOR TRANSMITTING AUDIO SIGNAL

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: FANG-YOU WANG, Shenzhen (CN); CHIH-HUA HSU, New Taipei (TW); HANG XU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/140,565

(22) Filed: Dec. 26, 2013

(30) Foreign Application Priority Data
Jan. 4, 2013 (CN) 2013100013702

(51) Int. Cl. G10L 19/00

(52) U.S. Cl. CPC G10L 19/00
USPC 704/201

(57) ABSTRACT

A method and a system for transmitting an audio signal are provided. The system includes a transmission device and a receiving device communicating with the transmission device via a network. The method includes receiving and sampling the audio signal, recording values of points of the sampled audio signal using the transmission device, segmenting the sampled audio signal into a plurality of frames, extracting and encoding characteristic information from each frame, to obtain a group of generated codes, transmitting each group of generated codes to a receiving device sequentially using the transmission device, and decoding each group of generated codes using the receiving device, to obtain a decoded audio signal.

### BACKGROUND

1. Technical Field

The present disclosure relates to communication systems, and particularly to a method and a system for transmitting audio signals.

2. Description of Related Art

Wireless audio transmission systems often transmit an entire audio signal at once. However, if the audio signal is large, transmission of the audio signal through a network uses up a large amount of data.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of an embodiment of an audio transmission system for transmitting audio signals.

FIG. 2(a) is a graph illustrating an audio signal to be transmitted, and FIG. 2(b) is a graph illustrating a decoded audio signal.

FIG. 3 is a data table illustrating a coding process and a decoding process of the audio signal of FIG. 2.

FIG. 4 is a flowchart illustrating a method for transmitting audio signals.

### DETAILED DESCRIPTION

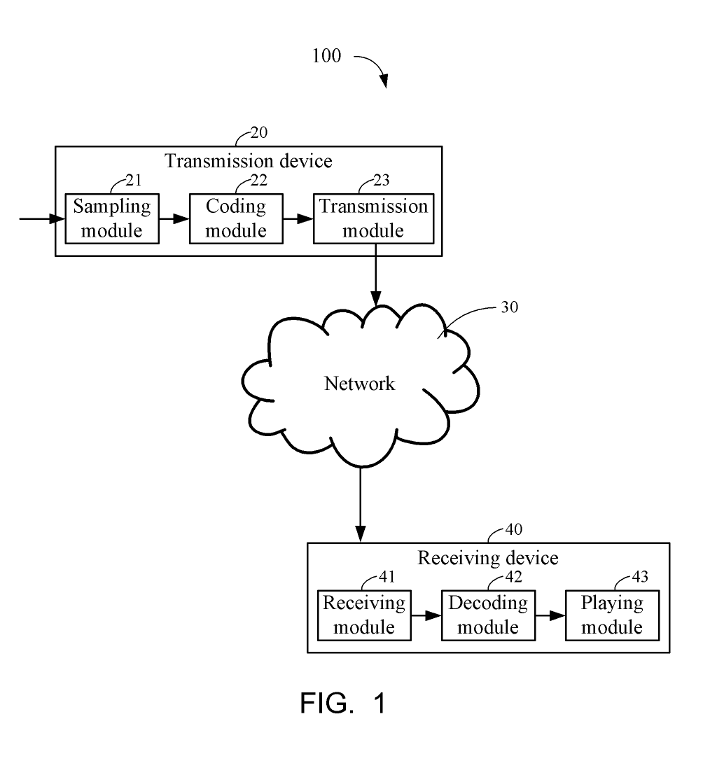

FIG. 1 shows an audio transmission system 100 for transmitting audio signals. The system 100 includes a transmission device 20, a network 30, and a receiving device 40. The transmission device 20 communicates with the receiving device 40 via the network 30. The network 30 can be, but is not limited to, a wireless communication network, or a wired network such as Internet.

The transmission device 20 includes a sampling module 21, a coding module 22, and a transmission module 23. In one embodiment, the coding module 22 is connected between the sampling module 21 and the transmission module 23. The sampling module 21 is configured to receive and sample an audio signal, and to record values of points of the sampled audio signal. The recorded values of the sampled audio signal include values corresponding to peaks and to valleys of the audio signal.

The coding module 22 is configured to search all recorded peak values (hereinafter “peaks”) and all recorded valley values (hereinafter “valleys”) of the sampled audio signal, and segment the sampled audio signal into a number of frames. One of two adjacent frames ends with a peak, and the other of the two adjacent frames ends with a valley. Therefore, each frame of the sampled audio signal starts with either a valley or a peak, and ends with either a peak or a valley correspondingly. The coding module 22 is further configured to extract and encode characteristic information from each frame of the sampled audio signal, to obtain a group of generated codes for each frame. The transmission module 23 is configured to transmit each group of generated codes to the receiving device 40 sequentially.

The receiving device 40 includes a receiving module 41, a decoding module 42, and a playing module 43. In one embodiment, the decoding module 42 is connected between the receiving module 41 and the playing module 43. The receiving module 41 is configured to receive each group of generated codes sequentially. The decoding module 42 is configured to decode each group of generated codes, to obtain a decoded audio signal. The playing module 43 is configured to receive and play each frame of the decoded audio signal sequentially. In one embodiment, the playing module 43 includes a digital-to-analog converter, an amplifier, and a speaker.

In one embodiment, the characteristic information of each frame includes a value of a starting peak/valley and of an ending valley/peak of the frame, and a value corresponding to how many recorded points are in the frame.

In one embodiment, a process for encoding the characteristic information of each frame of the sampled audio signal to obtain a group of generated codes is described below.

The coding module 22 defines a first mark character M1 and a second mark character M2. The first mark character M1 is configured to follow the value of the starting recorded point of the frame, and the second mark character M2 is configured to be followed by the value of the ending recorded point of the frame, and the amount of the recorded points of the frame is distributed between the first mark character M1 and the second mark character M2.

In one embodiment, the equation V={V1, V2, . . . , Vn} denotes the value of the recorded points of a frame of the sampled audio signal, and Vi (wherein i=1, 2, . . . , n) denotes the value of the i^{th} recorded point of the frame of the sampled audio signal. “V1” denotes the value of the starting recorded point, Vn denotes the value of the ending recorded point, and “n” denotes how many recorded points are in the frame of the sampled audio signal. Thus, V1, Vn, and n constitute the characteristic information, and the equation G={V1, M1, n, M2, Vn} denotes the generated codes. Therefore, when transmitting the generated codes of the frames of the audio signal, the audio transmission system 100 only needs to transmit five characters, which greatly increases efficiency of transmission.

Correspondingly, a process for decoding each group of generated codes is described below.

When the decoding module 42 receives the first marker character M1 and the second marker character M2 in a group of generated codes, the decoding module 42 determines the characteristic information of the frame of the sampled audio signal, calculates a step value S for each two adjacent recorded points according to the characteristic information, and then calculates the values of the rest of the recorded points of the frame according to the characteristic information and the step value. In one embodiment, the step value S is calculated as follows: S=((Vn−V1)/(n−1)). Therefore, the decoded values of the recorded points of each frame of the audio signal is calculated as follows: D={V1, V1+1*((Vn−V1)/(n−1)), V1+2*((Vn−V1)/(n−1)), . . . , V1+(n−1)*(Vn−V1)/(n−1)}.

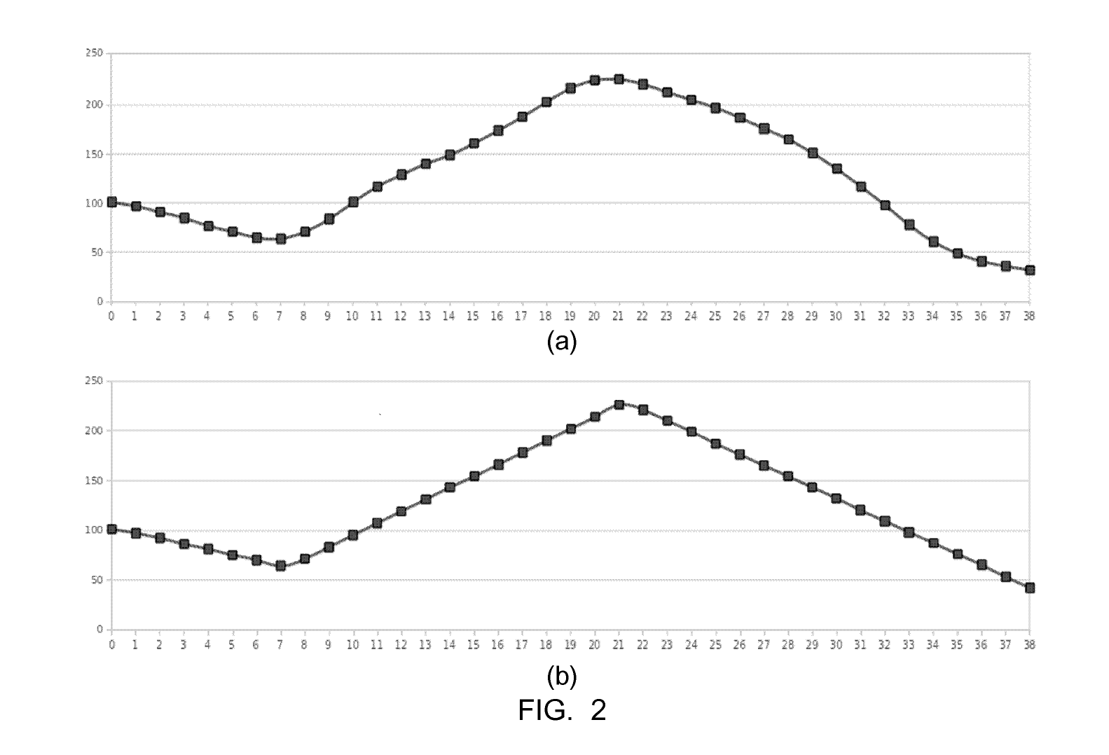

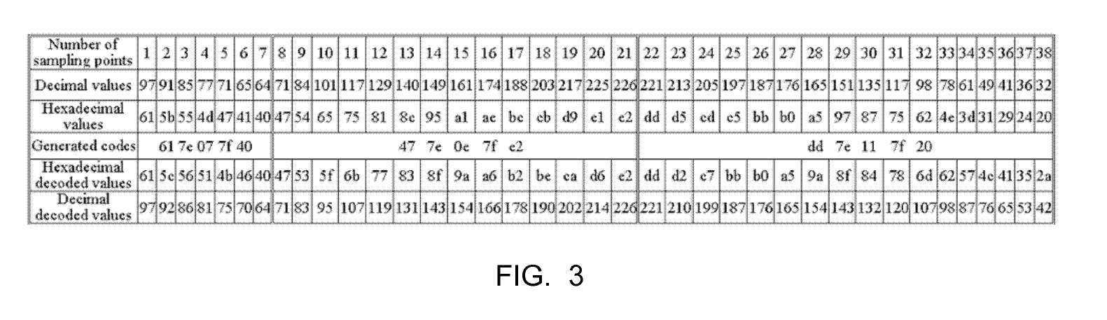

For example, FIG. 2(a) is a graph illustrating an audio signal to be transmitted, and FIG. 2(b) is a graph illustrating a decoded audio signal. FIG. 3 is a data table recording the value of each point of the audio signal to be transmitted, the generated codes of each frame of the audio signal, and the decoded value of each recorded point of the decoded audio signal.

In one embodiment, the recorded value of each point is assigned a value between 1 and FF in the hexadecimal system. Middle values 7e-83 in the hexadecimal system corresponding to the recorded values are approximated, and portions of the sampled audio signal corresponding to the middle values 7e-83 are considered as silent. Each of the first mark character M1 and the second mark character M2 can be selected from the middle values 7e-83.

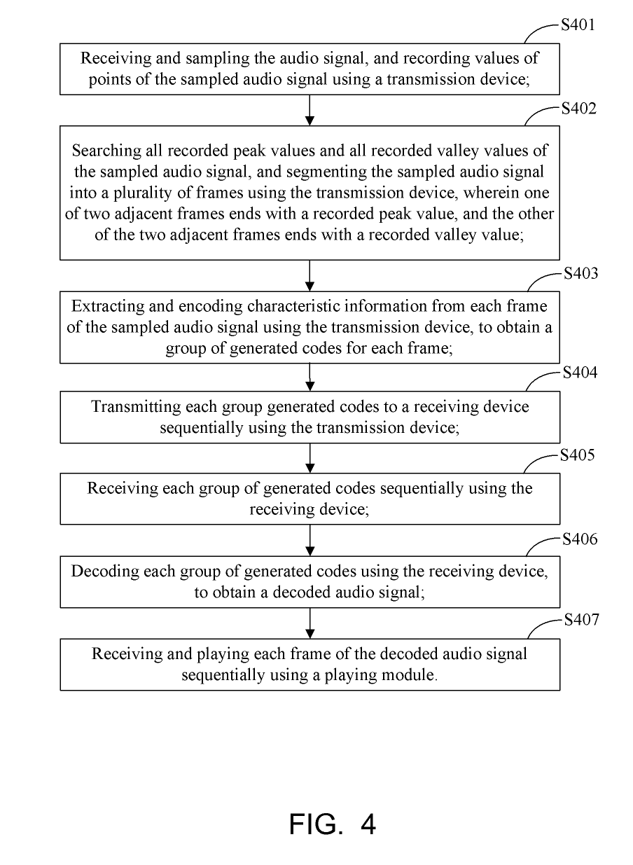

FIG. 4 is a flowchart illustrating a method for transmitting an audio signal.

In step S401, the sampling module 21 of the transmission device 20 receives and samples an audio signal (as shown in FIG. 2(a)), and records values of each point of the sampled audio signal. The recorded values of the sampled audio signal include values corresponding to peaks and to valleys of the audio signal.

In step S402, the coding module 22 searches all peaks and all valleys of the sampled audio signal, and segment the sampled audio signal into a number of frames. One of two adjacent frames ends with a peak, and the other of the two adjacent frames ends with a valley.

In step S403, the coding module 22 extracts and encodes characteristic information from each frame of the audio signal, to obtain a group of generated codes for each frame.

In one embodiment, the characteristic information of each frame includes a value of a starting peak/valley and an ending valley/peak of the frame, and a value corresponding to how many recorded points are in the frame.

In one embodiment, a process for encoding the characteristic information of each frame of the sampled audio signal to obtain a group of generated codes is described below.

The coding module 22 defines a first mark character M1 and a second mark character M2. The first mark character M1 is configured to follow the value of the starting recorded point of the frame, and the second mark character M2 is configured to be followed by the value of the ending recorded point of the frame, and the amount of the recorded points of the frame is distributed between the first mark character M1 and the second mark character M2. Thus, the generated codes G={V1, M1, n, M2, Vn}.

In step S404, the transmission module 23 transmits each group of generated codes to the receiving device 40 sequentially.

In step S405, the receiving module 41 receives each group of generated codes sequentially.

In step S406, the decoding module 42 decodes each group of generated codes, to obtain a decoded audio signal.

In the embodiment, a process for decoding each group of the generated codes is described below.

When the decoding module 42 receives the first marker character M1 and the second marker character M2 in a group of generated codes, the decoding module 42 determines the characteristic information of the frame of the sampled audio signal, calculates a step value S for each two adjacent recorded points according to the characteristic information, and then calculates the values of the rest of the recorded points of the frame according to the characteristic information and the step value. In one embodiment, the step value S is calculated as follows: S=((Vn−V1)/(n−1)). Therefore, the decoded values of the recorded points of each frame of the audio signal is calculated as follows: D={V1, V1+1*((Vn−V1)/(n−1)), V1+2*((Vn−V1)/(n−1)), . . . , V1+(n−1)*(Vn−V1)/(n−1)}.

In step S407, the playing module 43 receives and plays each frame of the decoded audio signal sequentially.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An audio transmission system for transmitting an audio signal, the system comprising:
a transmission device comprising:
a sampling module configured to receive and sample the audio signal, and to record values of points of the sampled audio signal;
a coding module configured to search all recorded peak values and all recorded valley values of the sampled audio signal, and segment the sampled audio signal into a plurality of frames, wherein one of two adjacent frames ends with a recorded peak value, and the other of the two adjacent frames ends with a recorded valley value;
the coding module further configured to extract and encode characteristic information from each frame of the sampled audio signal, to obtain a group of generated codes for each frame; and
a transmission module configured to transmit each group of generated codes to a receiving device sequentially; and
the receiving device communicating with the transmission device via a network, the receiving device comprising:
a receiving module configured to receive each group of generated codes sequentially, and
a decoding module configured to decode each group of generated codes, to obtain a decoded audio signal.

2. The system as described in claim 1, wherein the characteristic information of each frame comprises a value of a starting peak/valley value and an ending valley/peak value of the frame, and a value corresponding to how many recorded points are in the frame.

3. The system as described in claim 2, wherein the coding module defines a first mark character and a second mark character, and defines the first mark character and the second mark character, and the characteristic information of each frame to constitute the group of generated codes of the frame, wherein the first mark character is configured to follow the value of the starting recorded point of the frame, the second mark character is configured to be followed by the value of the ending recorded point of the frame, and the amount of the recorded points of the frame is distributed between the first mark character and the second mark character.

4. The system as described in claim 3, wherein when the decoding module receives the first marker character and the second marker character in a group of generated codes, the decoding module determines the characteristic information of the frame of the sampled audio signal, calculates a step value for each two adjacent recorded points according to the characteristic information, and then calculates the values of the rest of the recorded points of the frame according to the characteristic information and the step value.

5. The system as described in claim 1, wherein the receiving device further comprises a playing module configured to receive and play each frame of the decoded audio signal sequentially.

6. A method for transmitting an audio signal, the method comprising:
receiving and sampling the audio signal, and recording values of points of the sampled audio signal using a transmission device;
searching all recorded peak values and all recorded valley values of the sampled audio signal, and segmenting the sampled audio signal into a plurality of frames using the transmission device, wherein one of two adjacent frames ends with a recorded peak value, and the other of the two adjacent frames ends with a recorded valley value;
extracting and encoding characteristic information from each frame of the sampled audio signal using the transmission device, to obtain a group of generated codes for each frame;
transmitting each group of generated codes to a receiving device sequentially using the transmission device;
receiving each group of generated codes sequentially using the receiving device; and
decoding each group of generated codes using the receiving device, to obtain a decoded audio signal.

7. The method as described in claim 6, wherein the characteristic information of each frame comprises a value of a starting peak/valley value and an ending valley/peak value of the frame, and a value corresponding to how many recorded points are in the frame.

8. The method as described in claim 7, wherein the step of extracting and encoding characteristic information from each frame of the sampled audio signal using the transmission device, to obtain a group of generated codes for each frame comprises:
defining a first mark character and a second mark character;
defining the first mark character and the second mark character, and the characteristic information of each frame to constitute the group of generated codes of the frame, wherein the first mark character is configured to follow the value of the starting recorded point of the frame, the second mark character is configured to be followed by the value of the ending recorded point of the frame, and the amount of the recorded points of the frame is distributed between the first mark character and the second mark character.

9. The method as described in claim 8, wherein the step of decoding each group of generated codes using the receiving device, to obtain a decoded audio signal comprises:
determining the characteristic information of the frame of the sampled audio signal, when the receiving device receives the first marker character and the second marker character;
calculating a step value for each two adjacent recorded points according to the characteristic information; and
calculating the values of the rest of the recorded points of the frame according to the characteristic information and the step value.

10. The method as described in claim 6, further comprising receiving and playing each frame of the decoded audio signal sequentially using a playing module.
